(19) United States
(12) Patent Application Publication
(10) Pub. No.: US 2025/0357640 A1
(43) Pub. Date: Nov. 20, 2025

(54) CURRENT COLLECTOR ASSEMBLY WITH CURVED INTERCONNECT PORTIONS

(71) Applicant: Rivian IP Holdings, LLC, Irvine, CA (US)

(72) Inventors: Neil PATEL, Costa Mesa, CA (US); Kyle BUTTERFIELD, Ladera Ranch, CA (US); Kenton Robert HARRIS, Bloomington, IL (US); Leonel Caballero BANUELOS, Orange, CA (US); Samuel Edward HUGLEY, Long Beach, CA (US); Najmeh RAHIMI, Huntington Beach, CA (US)

(21) Appl. No.: 19/093,046

(22) Filed: Mar. 27, 2025

Related U.S. Application Data
(60) Provisional application No. 63/649,265, filed on May 17, 2024.

(51) Int. Cl. H01M 50/503

(52) U.S. Cl. CPC H01M 50/503; H01M 2220/20

(57) ABSTRACT

Interconnect portions of an electrically conductive layer may include different curvature profiles. Some interconnect portions include a curvature profile that allows the interconnect portion to span a distance of multiple tabs of the electrically conductive layer. Interconnect portions that span the distance of multiple tabs allow for battery packs with a reduced number of modules to have the same or similar voltage output as battery packs with a greater number of battery modules.

### CROSS REFERENCE TO RELATED APPLICATION(S)

The present application claims the benefit of U.S. Provisional Application No. 63/649,265, entitled “CURRENT COLLECTOR ASSEMBLY WITH CURVED INTERCONNECT PORTIONS”, filed May 17, 2024, the entirety of which is incorporated herein for reference.

### INTRODUCTION

Batteries are often used as a source of power, including as a source of power for electric vehicles that include wheels that are driven by an electric motor that receives power from the batteries. A battery may include several battery cells carried within a module and/or a carrier.

Aspects of the subject technology can help to improve the durability and longevity of batteries of electric vehicles, which can help to mitigate climate change by reducing greenhouse gas emissions.

### SUMMARY

A current collector assembly (CCA) for a battery module may include an electrically conductive layer with several interconnect portions, some of which are connected to multiple interconnect portions. In particular, some interconnect portions include different curvature profiles (e.g., a different radius of curvature) than other interconnect portions. Some interconnect portions include a relatively smaller radius of curvature and as a result may curve to extend around and/or between multiple tabs used to connect to battery cells. Some battery modules are designed to provide output (e.g., voltage output) at certain characteristics based on electrical connections in series and in parallel among the battery cells of the battery module. However, when the number of battery modules is reduced, so too is the number of battery cells. This may lead to a change (e.g., reduction) in the voltage output. However, based on the interconnect portions, the desired output (e.g., prior voltage output with greater battery modules) may be achieved with fewer battery cells and without having to rearrange other features of the electrically conductive layer (e.g., tabs, other interconnect portions).

According to one or more implementations of the present disclosure, an apparatus is described. The apparatus may include a current collector assembly that includes an electrically conductive layer. The electrically conductive layer may include a first interconnect portion connected to a first tab and to a second tab. The electrically conductive layer may further include a second interconnect portion. The electrically conductive layer may further include a third interconnect portion connected to the first interconnect portion and the second interconnect portion. The third interconnect portion may span from at least the first tab to the second tab. The first tab may be separated from the second tab by a first distance, and the third interconnect portion may span a second distance greater than the first distance. The third interconnect portion may include a first width, and a second width different from the first width.

The first interconnect portion may include a third tab. The third interconnect portion may span from at least the first tab, the second and the third tab. The second interconnect portion may include a fourth tab, and the third interconnect portion may be positioned between the third tab and the fourth tab.

The second interconnect portion may include a fifth tab, the fourth tab may be separated from the fifth tab by a first distance, and the third interconnect portion may span a second distance greater than the first distance.

The third interconnect portion may be positioned between the third tab and the fifth tab. The third interconnect portion may be positioned between the second tab and the fifth tab.

According to one or more implementations of the present disclosure, a battery subassembly is described. The battery subassembly may include a current collector assembly electrically coupled with one or more battery cells. The current collector assembly may include an electrically conductive layer that includes a first tab extending from a first interconnect portion. The electrically conductive layer may further include a second tab extending from a second interconnect portion. The electrically conductive layer may further include a third interconnect portion. The third interconnect portion may include a first section extending from the first interconnect portion. The third interconnect portion may further include a second section extending from the second interconnect portion. The third interconnect portion may further include a third section connected to the first section and the second section. The third section may be positioned between the first tab and the second tab and spans from at least the first tab to the second tab. The first interconnect portion may be parallel with respect to the second interconnect portion.

The third interconnect portion may further include a first width, and a second width different from the first width. The electrically conductive layer may further include a third tab extending from the first interconnect portion. The first tab and the third tab may be separated by a first distance, and the third interconnect portion may span a second distance greater than the first distance.

The electrically conductive layer may further include a fourth interconnect portion positioned between the first interconnect portion and the second interconnect portion. The electrically conductive layer may further include a fifth interconnect portion. The electrically conductive layer may further include a sixth interconnect portion connected to the fourth interconnect portion and the fifth interconnect portion. The third interconnect portion may a first distance, and The sixth interconnect portion may span a second distance less than the second distance. The fourth interconnect portion may be parallel with respect to the first interconnect portion and with respect to the second interconnect portion.

The battery subassembly of claim 13, further including a third tab extending from the fourth interconnect portion. The one or more battery cells may include a first battery cell electrically connected to the first tab. The one or more battery cells may further include a second battery cell electrically connected to the second tab. The second battery cell may be electrically connected in parallel with the first battery cell. The one or more battery cells may further include a third battery cell electrically connected to the second tab. The third battery cell may be electrically connected in series with the first battery cell and the second battery cell. The first tab may be configured to electrically connect to a positive terminal of the first battery cell, and the third tab may be configured to electrically connect to a negative terminal of the third battery cell.

According to one or more implementations of the present disclosure, a vehicle is described. The vehicle may include a current collector assembly that includes an electrically conductive layer. The electrically conductive layer may include a first interconnect portion connected to a first tab and to a second tab. The electrically conductive layer may further include a second interconnect portion. The electrically conductive layer may further include a third interconnect portion connected to the first interconnect portion and the second interconnect portion. The third interconnect portion may span from at least the first tab to the second tab.

The third interconnect portion may include a first section extending from the first interconnect portion. The third interconnect portion may further include a second section extending from the second interconnect portion. The third interconnect portion may further include a third section connected to the first section and the second section. The third section may be positioned between the first tab and the second tab. The first section may include a first width, and the third section may include a second width different from the first width.

The electrically conductive layer may further include a fourth interconnect portion positioned between the first interconnect portion and the second interconnect portion. The electrically conductive layer may further include a fifth interconnect portion. The electrically conductive layer may further include a sixth interconnect portion connected to the fourth interconnect portion and the fifth interconnect portion. The third interconnect portion may a first distance, and the sixth interconnect portion may span a second distance less than the second distance.

The electrically conductive layer may further include a third tab extending from the fourth interconnect portion. The one or more battery cells may include a first battery cell electrically connected to the first tab. The one or more battery cells may further include a second battery cell electrically connected to the second tab. The second battery cell may be electrically connected in parallel with the first battery cell. The one or more battery cells may further include a third battery cell electrically connected to the second tab. The second battery cell may be electrically connected in series with the first battery cell and the second battery cell.

### BRIEF DESCRIPTION OF THE DRAWINGS

Certain features of the subject technology are set forth in the appended claims. However, for purpose of explanation, several embodiments of the subject technology are set forth in the following figures.

FIG. 1A and FIG. 1B illustrate schematic perspective side views of example implementations of a vehicle having a battery pack, in accordance with one or more implementations of the present disclosure.

FIG. 1C illustrates a schematic perspective view of a building having a battery pack, in accordance with one or more implementations of the present disclosure.

FIG. 2A illustrates a schematic perspective view of a battery pack, in accordance with one or more implementations of the present disclosure.

FIG. 2B illustrates schematic perspective views of various battery modules that may be included in a battery pack, in accordance with one or more implementations of the present disclosure.

FIG. 2C illustrates a cross-sectional end view of a battery cell, in accordance with one or more implementations of the present disclosure.

FIG. 2D illustrates a cross-sectional perspective view of a cylindrical battery cell, in accordance with one or more implementations.

FIG. 2E illustrates a cross-sectional perspective view of a prismatic battery cell, in accordance with one or more implementations of the present disclosure.

FIG. 2F illustrates a cross-sectional perspective view of a pouch battery cell, in accordance with one or more implementations of the present disclosure.

FIG. 3 illustrates a perspective view of a cover for a battery module in accordance with one or more implementations of the present disclosure.

FIG. 4 illustrates an exploded perspective view of the battery module shown in FIG. 3 in accordance with one or more implementations of the present disclosure.

FIG. 5 illustrates a perspective view of an example battery cell in accordance with one or more implementations of the present disclosure.

FIG. 6A, FIG. 6B, and FIG. 6C illustrate perspective views of examples of battery packs in accordance with one or more implementations of the present disclosure.

FIG. 7 illustrates a plan view of a current collector assembly for a battery module in accordance with one or more implementations.

FIG. 8 illustrates an enlarged plan view of the current collector assembly of Section A in FIG. 7, showing additional features in accordance with one or more implementations of the present disclosure.

FIG. 9 illustrates an additional enlarged plan view of the current collector assembly shown in FIG. 8, showing additional features in accordance with one or more implementations of the present disclosure.

FIG. 10 illustrates an additional enlarged plan view of the current collector assembly shown in FIG. 7, showing features of the voltage sense harness in accordance with one or more implementations of the present disclosure.

FIG. 11 illustrates a flow diagram showing an example of a process that may be performed for forming a current collector assembly in accordance with one or more implementations of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The subject technology is directed to CCAs with an electrically conductive layer having different interconnect portions with different curvature profiles. For example, some interconnect portions include a smaller radius of curvature that allows the interconnect portion to extend around and/or between several tabs. In order for battery cells of a battery module to provide a desired output (e.g., voltage output), the battery cells may be connected electrically in series and in parallel in a particular manner. However, when the number of battery modules (having several battery cells) changes, the desired output changes. In order to retain the desired output, the interconnect portions described herein may provide connections that connect different battery cells electrically in series and in parallel. Moreover, the use of interconnect portions described herein may minimize the design changes to other features (e.g., tabs connected to battery cells, other interconnect portions). Still further, the changes to manufacturing may also be minimized, as the tooling and welding lines may undergo minimal, if any, changes. Beneficially, interconnect portions described herein may be used maintain a desired output when the number of battery cells is reduced, while also minimizing overall manufacturing costs.

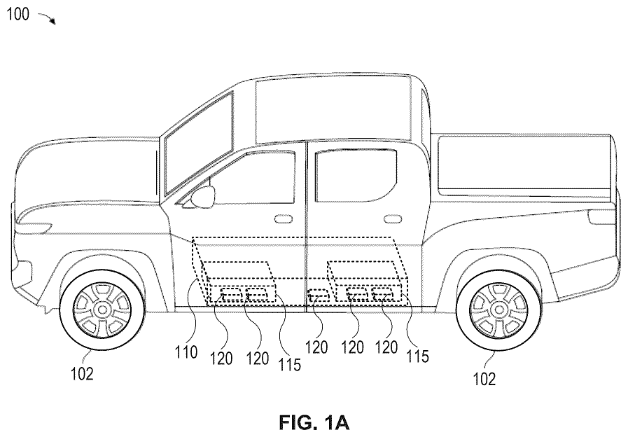

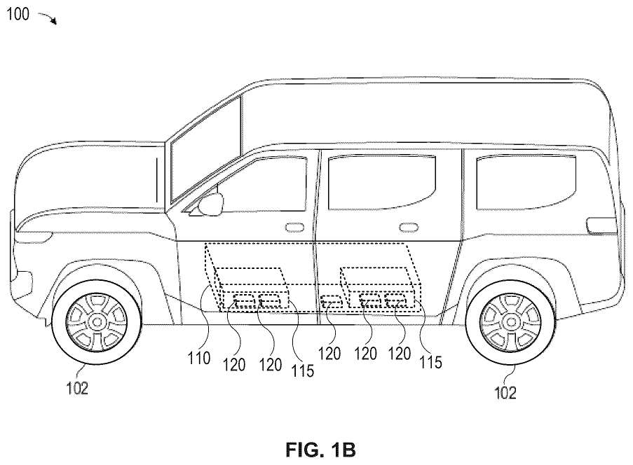

FIG. 1A illustrates an example implementation of a moveable apparatus as described herein. In the example of FIG. 1A, a moveable apparatus is implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors that drive the wheels 102 of the vehicle 100 using electric power from the battery pack 110. In one or more implementations, the vehicle 100 may also, or alternatively, include one or more engines, or motors, including chemically-powered engines, such as a gas-powered engine or a fuel cell powered motor. For example, in one or more implementations, the vehicle 100 includes one or more electric motors, and the vehicle 100 takes the form of a fully electric or partially electric (e.g., hybrid or plug-in hybrid) vehicle.

In the example of FIG. 1A, the vehicle 100 is implemented as a truck (e.g., a pickup truck) having a battery pack 110. As shown, the battery pack 110 may include one or more battery modules 115, which may include one or more battery cells 120. As shown in FIG. 1A, the battery pack 110 may also, or alternatively, include one or more battery cells 120 mounted directly in the battery pack 110 (e.g., in a cell-to-pack configuration). In one or more implementations, the battery pack 110 may be provided without the battery modules 115 and with the battery cells 120 mounted directly in the battery pack 110 (e.g., in a cell-to-pack configuration) and/or in other battery units that are installed in the battery pack 110. The battery pack 110 may include multiple energy storage devices that can be arranged into such as battery modules or battery units. A battery unit or module can include an assembly of cells that can be combined with other elements (e.g., structural frame, thermal management devices) that can protect the assembly of cells from heat, shock and/or vibrations.

Each of the battery cells 120 may be included a battery, a battery unit, a battery module and/or a battery pack to power components of the vehicle 100. For example, a battery cell housing of the battery cells 120 can be disposed in the battery module 115, the battery pack 110, a battery array, or other battery unit installed in the vehicle 100.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery module 115. In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into AC power for one or more components and/or systems of the vehicle (e.g., including one or more power outlets of the vehicle). The power stage circuit can be provided as part of the battery pack 110 or separately from the battery pack 110 within the vehicle 100.

FIG. 1B illustrates another implementation in which the vehicle 100 is implemented as a sport utility vehicle (SUV), such as an electric sport utility vehicle. In the example of FIG. 1B, the vehicle 100 may include a cargo storage area that is enclosed within the vehicle 100 (e.g., behind a row of seats within a cabin of the vehicle 100). In other implementations, the vehicle 100 may be implemented as another type of electric truck, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the moveable apparatus).

In one or more implementations, the battery pack 110, battery modules 115, battery cells 120, and/or any other battery unit as described herein may also, or alternatively, be implemented as an electrical power supply and/or energy storage system in a building, such as a residential home or commercial building. For example, FIG. 1C illustrates an example in which a battery pack 110a is implemented in a building 180. The building 180 may be a residential building, a commercial building, or any other building. As shown, in one or more implementations, the battery pack 110a may be mounted to a wall of the building 180.

As shown, the battery pack 110a that is installed in the building 180 may be coupled (e.g., electrically coupled) to the battery pack 110b in the vehicle 100, such as via a cable/connector 106 that can be connected to a charging port 130 of the vehicle 100, an electric vehicle supply equipment 170 (EVSE), a power stage circuit 172, and/or a cable/connector 174. For example, the cable/connector 106 may be coupled to the EVSE 170, which may be coupled to the battery pack 110a via the power stage circuit 172, and/or may be coupled to an external power source 190. In this way, either the external power source 190 or the battery pack 110a may be used as an external power source to charge the battery pack 110b in some use cases. In one or more implementations, the battery pack 110a may also, or alternatively, be coupled (e.g., via a cable/connector 174, the power stage circuit 172, and the EVSE 170) to the external power source 190. The external power source 190 may take the form of a solar power source, a wind power source, and/or an electrical grid of a city, town, or other geographic region (e.g., electrical grid that is powered by a remote power plant). During, for example, instances when the battery pack 110b is not coupled to the battery pack 110a, the battery pack 110a may couple (e.g., using the power stage circuit 172) to the external power source 190 to charge up and store electrical energy. In some use cases, this stored electrical energy in the battery pack 110a may later be used to charge the battery pack 110b (e.g., during times when solar power or wind power is not available, in the case of a regional or local power outage for the building 180, and/or during a period of high rates for access to the electrical grid).

In one or more implementations, the power stage circuit 172 may electrically couple the battery pack 110a to an electrical system of the building 180. For example, the power stage circuit 172 may convert DC power from the battery pack 110a into AC power for one or more loads in the building 180. Exemplary loads coupled, via one or more electrical outlets coupled, to the battery pack 110a may include one or more lights, lamps, appliances, fans, heaters, air conditioners, and/or any other electrical components or electrical loads. The power stage circuit 172 may include control circuitry that is operable to switchably couple the battery pack 110a between the external power source 190 and one or more electrical outlets and/or other electrical loads in the electrical system of the building 180. In one or more implementations, the vehicle 100 may include a power stage circuit (not shown in FIG. 1C) that can be used to convert power received from the EVSE 170 to DC power that is used to power/charge the battery pack 110b, and/or to convert DC power from the battery pack 110 into AC power for one or more electrical systems, components, and/or loads of the vehicle 100.

In one or more use cases, the battery pack 110a may be used as a source of electrical power for the building 180, such as during times when solar power or wind power is not available, in the case of a regional or local power outage for the building 180, and/or during a period of high rates for access to the electrical grid, as non-limiting examples. In one or more other use cases, the battery pack 110b may be used to charge the battery pack 110a and/or to power the electrical system of the building 180 (e.g., in a use case in which the battery pack 110a is low on or out of stored energy and in which solar power or wind power is not available, a regional or local power outage occurs for the building 180, and/or a period of high rates for access to the electrical grid occurs, as non-limiting examples.

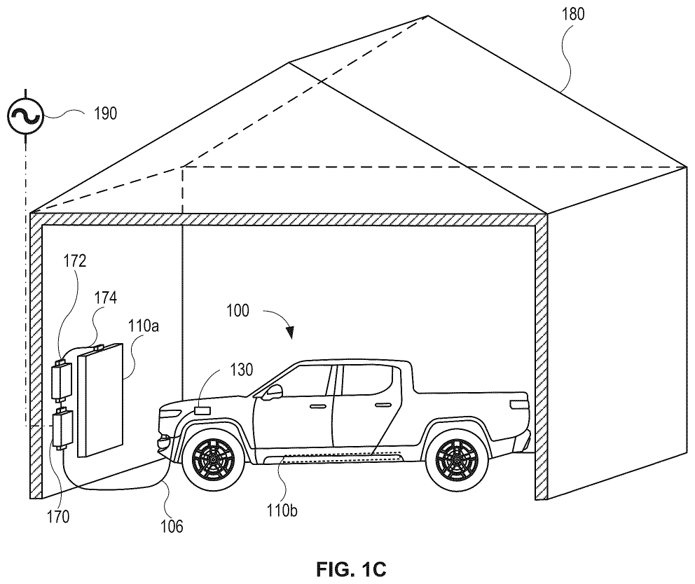

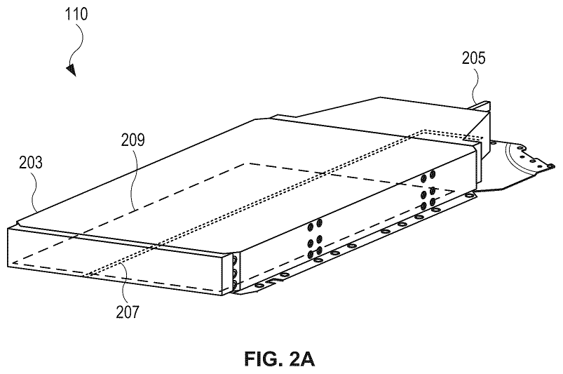

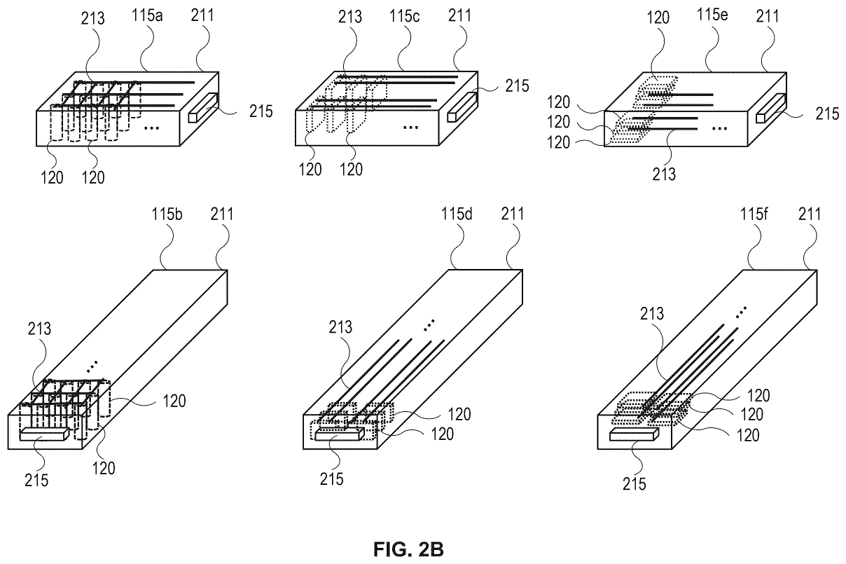

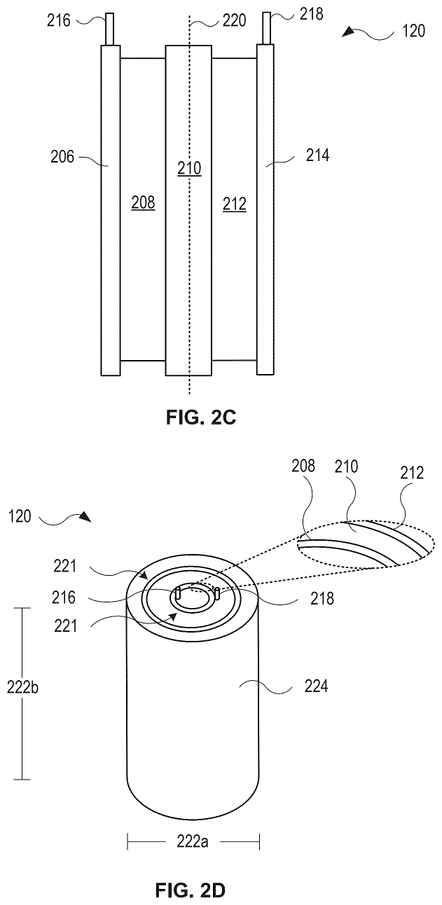

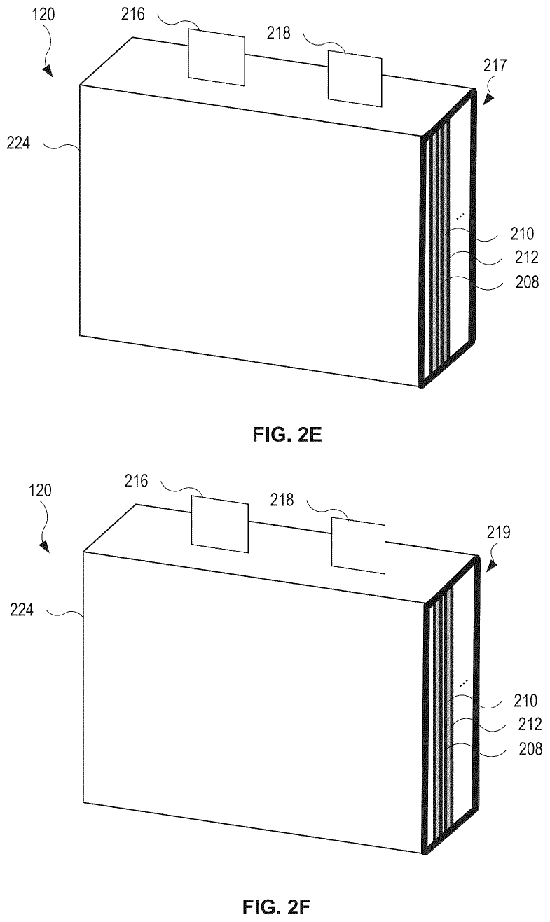

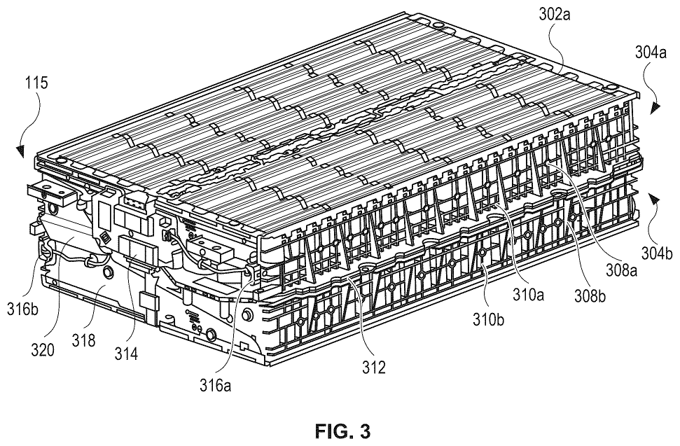

FIG. 2A illustrates an example of a battery pack 110. As shown, the battery pack 110 may include a battery pack frame 203 (e.g., a battery pack housing or pack frame). The battery pack frame 203 may house or enclose one or more battery modules and/or one or more battery cells, and/or other battery pack components of the battery pack 110. In one or more implementations, the battery pack frame 203 may include or form a shielding structure on an outer surface thereof (e.g., a bottom thereof and/or underneath one or more battery module, battery units, batteries, and/or battery cells) to protect the battery module, battery units, batteries, and/or battery cells from external conditions (e.g., if the battery pack 110 is installed in a vehicle and the vehicle is driven over rough terrain, such as off-road terrain, trenches, rocks, rivers, streams, etc.).

The battery pack 110 may include battery cells (e.g., directly installed within the battery pack 110, or within batteries, battery units, and/or battery modules as described herein) and/or battery modules, and one or more conductive coupling elements for coupling a voltage generated by the battery cells to a power-consuming component, such as the vehicle 100 (shown in FIGS. 1A, 1B, and 1C) and/or an electrical system of the building 180 (shown in FIG. 1C). For example, the conductive coupling elements may include internal connectors and/or contactors that couple together multiple battery cells, battery units, batteries, and/or multiple battery modules within the battery pack frame 203 to generate a desired output voltage for the battery pack 110. The battery pack 110 may also include one or more external connection ports, such as an electrical contact 205 (e.g., a high voltage terminal or connector). As shown, the battery pack 110 may include an electrical contact 205 may electrically couple an external load (e.g., the vehicle or an electrical system of the building) to the battery modules and/or battery cells in the battery pack 110. In this regard, an electrical cable (e.g., cable/connector 106) may be connected between the electrical contact 205 and an electrical system of a vehicle or a building, to provide electrical power to the vehicle or the building.

In one or more implementations, the battery pack 110 may include one or more thermal control structures 207 (e.g., cooling lines and/or plates and/or heating lines and/or plates). For example, thermal control structures 207 may couple thermal control structures and/or fluids to the battery modules, battery units, batteries, and/or battery cells within the battery pack frame 203, such as by distributing fluid through the battery pack 110. The thermal control structures 207 may form a part of a thermal/temperature control or heat exchange system that includes one or more thermal components 209, which may include plates or bladders that are disposed in thermal contact with one or more battery modules and/or battery cells disposed within the battery pack frame 203. The one or more thermal components 209 may be positioned in contact with one or more battery modules, battery units, batteries, and/or battery cells within the battery pack frame 203. The one or multiple thermal control structures 207 may be provided for each of several top and bottom battery module pairs.

FIG. 2B depicts various examples of battery modules that may be disposed in a battery pack (e.g., within the battery pack frame 203 of the battery pack 110, shown in FIG. 2A). In an example of FIG. 2B, a battery module 115a is shown that includes a battery module housing 211 having a rectangular cuboid shape with a length that is substantially similar to its width. In this example, the battery module 115a includes battery cells 120 implemented as cylindrical battery cells. The battery module 115a further includes rows and columns of cylindrical battery cells that are coupled together by an interconnect structure 213 (e.g., a current connector assembly or CCA). For example, the interconnect structure 213 may couple together the positive terminals of the battery cells 120, and/or couple together the negative battery terminals of the battery cells 120. As shown, the battery module 115a may further include a bus bar 215 that functions as a charge collector. For example, the bus bar 215 may be electrically coupled to the interconnect structure 213 to collect the charge generated by the battery cells 120 to provide a high voltage output from the battery module 115a.

FIG. 2B also shows a battery module 115b having an elongate shape. The battery module 115b may include a battery module housing 211 in which the length of the (e.g., extending along a direction from a front end to a rear end of the battery module housing 211) is substantially greater than a width (e.g., in a transverse direction to the direction from the front end to the rear end) of the battery module housing 211). In this regard, the battery module 115b (representative of one or more similar battery modules) may span the entire front-to-back length of a battery pack within a battery pack frame. As shown, the battery module 115a may further include an interconnect structure 213 electrically coupled to a bus bar 215, allowing the bus bar 215 may be electrically coupled to the interconnect structure 213 to collect the charge generated by battery cells 120 of the battery module 115b to provide a high voltage output from the battery module 115b.

In the implementations of battery module 115a and battery module 115a, the battery cells 120 are implemented as cylindrical battery cells. However, in other implementations, a battery module may include battery cells having other form factors, such as a battery cells having a right prismatic outer shape (e.g., a prismatic cell), or a pouch cell implementation of a battery cell. As an example, FIG. 2B also shows a battery module 115c having a battery module housing 211 with a rectangular cuboid shape with a length that is substantially similar to its width and including battery cells 120 implemented as prismatic battery cells. In this example, the battery module 115c includes rows and columns of battery cells 120 that are coupled together by an interconnect structure 213 (e.g., a current collector assembly or CCA). For example, the interconnect structure 213 may couple together the positive terminals of the battery cells 120 and/or couple together the negative battery terminals of the battery cells 120. As shown, the battery module 115c may include a bus bar 215 that functions as a charge collector. For example, the bus bar 215 may be electrically coupled to the interconnect structure 213 to collect the charge generated by the battery cells 120 to provide a high voltage output from the battery module 115c.

FIG. 2B also shows a battery module 115d including prismatic battery cells and having an elongate shape. For example, the battery module 115d includes a battery module housing 211 in which the length of the battery module housing 211 is substantially greater than a width of the battery module housing 211. In this regard, the battery module 115d (representative of one or more similar battery modules) may span the entire front-to-back length of a battery pack within a battery pack frame. As shown, the battery module 115d may also include an interconnect structure 213 and a bus bar 215 electrically coupled to the interconnect structure 213. For example, the bus bar 215 may be electrically coupled to the interconnect structure 213 to collect the charge generated by the battery cells 120 to provide a high voltage output from the battery module 115d.

As another example, FIG. 2B also shows a battery module 115e having a battery module housing 211 having a rectangular cuboid shape with a length that is substantially similar to its width. The battery module housing 211 may carry battery cells 120, each of which being implemented as pouch battery cells. In this example, the battery module 115e includes rows and columns of pouch battery cells that are coupled together by an interconnect structure 213 (e.g., a current collector assembly or CCA). For example, the interconnect structure 213 may couple together the positive terminals of the battery cells 120 and couple together the negative battery terminals of the battery cells 120. As shown, the battery module 115e may also include a bus bar 215 electrically coupled to the interconnect structure 213. For example, the bus bar 215 may be electrically coupled to the interconnect structure 213 to collect the charge generated by the battery cells 120 to provide a high voltage output from the battery module 115e.

FIG. 2B also shows a battery module 115f including pouch battery cells and having an elongate shape. For example, the battery module 115d includes a battery module housing 211 in which the length of the battery module housing 211 is substantially greater than a width of the battery module housing 211. In this regard, the battery module 115d (representative of one or more similar battery modules) may span the entire front-to-back length of a battery pack within a battery pack frame. In this regard, the battery module 115f (representative of one or more similar battery modules) may span the entire front-to-back length of a battery pack within a battery pack frame. As shown, the battery module 115f may also include an interconnect structure 213 and a bus bar 215 electrically coupled to the interconnect structure 213. For example, the bus bar 215 may be electrically coupled to the interconnect structure 213 to collect the charge generated by the battery cells 120 to provide a high voltage output from the battery module 115f.

In various implementations, a battery pack (e.g., battery pack 110 shown in FIG. 2A) may be provided with one or more of any of the battery modules 115a, 115b, 115c, 115d, 115e, and 115f. In one or more other implementations, a battery pack may be provided without any of the battery modules 115a, 115b, 115c, 115d, 115e, and 115f (e.g., in a cell-to-pack implementation).

In one or more implementations, battery modules in any of the implementations of FIG. 2B may be coupled (e.g., in series) to a current collector of a battery pack. In one or more implementations, the current collector may be coupled, via a high voltage harness, to one or more external connectors on a battery pack (e.g., electrical contact 205 of the battery pack 110, shown in FIG. 2A). In one or more implementations, a battery pack may be provided without any battery modules 115. For example, in a cell-to-pack configuration, the battery cells 120 are arranged directly into a battery pack without assembly into a battery module (e.g., without including the battery module housing 211). For example, a battery pack frame of a battery pack (e.g., the battery pack frame 203 of the battery pack 110 shown in FIG. 2A) may include or define a plurality of structures for positioning of the battery cells 120 directly within the battery pack frame.

FIG. 2C illustrates a cross-sectional end view of a portion of a battery cell 120. As shown, the battery cell 120 may include an anode 208, an electrolyte 210, and a cathode 212. As shown, the anode 208 may include or be electrically coupled to a first current collector 206 (e.g., a metal layer such as a layer of copper foil or other metal foil). Also, the cathode 212 may include or be electrically coupled to a second current collector 214 (e.g., a metal layer such as a layer of aluminum foil or other metal foil). The battery cell 120 may further include a terminal 216 (e.g., a negative terminal) coupled to the anode 208 (e.g., via the first current collector 206) and a terminal 218 (e.g., a positive terminal) coupled to the cathode (e.g., via the second current collector 214). In various implementations, the electrolyte 210 may take the form of a liquid electrolyte layer or a solid electrolyte layer. In one or more implementations in which the electrolyte 210 is a liquid electrolyte layer, the battery cell 120 may include a separator layer 220 that separates the anode 208 from the cathode 212. In one or more implementations in which the electrolyte 210 is a solid electrolyte layer, the electrolyte 210 may function as both separator layer and an electrolyte layer.

In one or more implementations, the battery cell 120 may be implemented as a lithium ion battery cell in which the anode 208 is formed from a carbonaceous material (e.g., graphite or silicon-carbon). In these implementations, lithium ions can move from the anode 208, through the electrolyte 210, to the cathode 212 during discharge of the battery cell 120 (e.g., and through the electrolyte 210 from the cathode 212 to the anode 208 during charging of the battery cell 120). For example, the anode 208 may be formed from a graphite material that is coated on a copper foil corresponding to the first current collector 206. In these lithium ion implementations, the cathode 212 may be formed from one or more metal oxides (e.g., a lithium cobalt oxide, a lithium manganese oxide, a lithium nickel manganese cobalt oxide (NMC), or the like) and/or a lithium iron phosphate. In an implementation in which the battery cell 120 is implemented as a lithium-ion battery cell, the electrolyte 210 may include a lithium salt in an organic solvent.

The separator layer 220 may be formed from one or more insulating materials (e.g., a polymer such as polyethylene, polypropylene, polyolefin, and/or polyamide, or other insulating materials such as rubber, glass, cellulose or the like). The separator layer 220 may prevent contact between the anode 208 and the cathode 212, and may be permeable to the electrolyte 210 and/or ions within the electrolyte 210. In one or more implementations, the battery cell 120 may be implemented as a lithium polymer battery cell having a dry solid polymer electrolyte and/or a gel polymer electrolyte.

Although some examples are described herein in which the battery cell 120 is implemented as lithium-ion battery cells, the battery cell 120 may be implemented using other battery cell technologies, such as nickel-metal hydride battery cells, lead-acid battery cells, and/or ultracapacitor cells. For example, in a nickel-metal hydride battery cell, the anode 208 may be formed from a hydrogen-absorbing alloy and the cathode 212 may be formed from a nickel oxide-hydroxide. In the example of a nickel-metal hydride battery cell, the electrolyte 210 may be formed from an aqueous potassium hydroxide in one or more examples.

The battery cell 120 may be implemented as a lithium sulfur battery cell in one or more other implementations. For example, in a lithium sulfur battery cell, the anode 208 may be formed at least in part from lithium, the cathode 212 may be formed from at least in part form sulfur, and the electrolyte 210 may be formed from a cyclic ether, a short-chain ether, a glycol ether, an ionic liquid, a super-saturated salt-solvent mixture, a polymer-gelled organic media, a solid polymer, a solid inorganic glass, and/or other suitable electrolyte materials. In various implementations, the anode 208, the electrolyte 210, and the cathode 212 can be packaged into a battery cell housing having any of various shapes, and/or sizes, and/or formed from any of various suitable materials. For example, the battery cell 120 may include a cylindrical, rectangular, square, cubic, flat, pouch, elongated, or prismatic outer shape.

As depicted in FIG. 2D, for example, a battery cell 120 may be implemented as a cylindrical cell. Accordingly, the battery cell 120 includes dimension 222a (e.g., cylinder diameter, battery cell diameter) and a dimension 222b (e.g., cylinder length). The battery cell 120, and other battery cells described herein, may include dimensional information derived from a 4-number code. For example, in some embodiments, the battery cell 120 includes an XXYY battery cell, in which “XX” refers to the dimension 222a in millimeters (mm) and “YY” refers to the dimension in mm. Accordingly, when the battery cell 120 includes a “2170” battery cell, the dimension 222a is 21 mm and the dimensions 222b is 70 mm. Alternatively, when the battery cell 120 includes a “4680” battery cell, the dimension 222a is 46 mm and the dimensions 222b is 80 mm. The foregoing examples of dimensional characteristics for the battery cell 120 should not be construed as limiting, and the battery cell 120, and other battery cells described herein with a cylindrical form factor, may include various dimension. For example, the dimension 222a and the dimension 222b may be greater than 46 mm and 80 mm, respectively.

FIG. 2D illustrates a battery cell 120 that includes a cell housing 224 having a cylindrical outer shape. As shown in the enlarged view, the anode 208, the electrolyte 210, and the cathode 212 may be rolled into one or more windings 221. The one or more windings 221 may include one or more substantially cylindrical windings, as a non-limiting example. As shown, one or more windings 221 of the anode 208, the electrolyte 210, and the cathode 212 (e.g., and/or one or more separator layers such as separator layer 220 shown in FIG. 2C) may be disposed within the cell housing 224. For example, a separator layer may be disposed between adjacent ones of the one or more windings 221. Additionally, the battery cell 120 in the cylindrical cell implementation of FIG. 2D includes a terminal 216 and a terminal 218. The terminal 218 may include a first polarity terminal, such as a positive terminal, which is coupled to the cathode 212. The terminal 216 may include a second polarity terminal, such as a negative terminal, which is coupled to the anode 208. The terminals 216 and 218 can be made from electrically conductive materials to carry electrical current from the battery cell 120 directly or indirectly (e.g., via a current carrier assembly, a bus bar, and/or other electrical coupling structures) to an electrical load, such as a component or system of a vehicle or a building shown and/or described herein. However, the cylindrical cell implementation of FIG. 2D is merely illustrative, and other implementations of the battery cells 120 are contemplated.

FIG. 2E illustrates an example in which the battery cell 120 is implemented as a prismatic cell. As shown, the battery cell 120 may include a cell housing 224 having a right prismatic outer shape. Also, one or more layers of the anode 208, the cathode 212, and the electrolyte 210 disposed therebetween may be disposed (e.g., with separator materials between the layers) within the cell housing 224. As examples, multiple layers of the anode 208, electrolyte 210, and cathode 212 can be stacked (e.g., with separator materials between each layer), or a single layer of the anode 208, electrolyte 210, and cathode 212 can be formed into a flattened spiral shape and provided in the cell housing 224. The cell housing 224 may include a cross-sectional width 217 that is relatively thick and is formed from a rigid material. For example, the cell housing 224 may be formed from a welded, stamped, deep drawn, and/or impact extruded metal sheet, such as a welded, stamped, deep drawn, and/or impact extruded aluminum sheet. The cross-sectional width 217 of the cell housing 224 may be as much as, or more than 1 millimeter (mm) to provide a rigid housing for the prismatic battery cell. In one or more implementations, a terminal 216 and a terminal 218 in the prismatic cell implementation of FIG. 2E may be formed from a feedthrough conductor that is insulated from the cell housing 224 (e.g., a glass to metal feedthrough) as the conductor passes through to cell housing 224 to expose the terminal 216 and the terminal 218 outside the cell housing 224 in order to contact an interconnect structure (e.g., interconnect structure 213 shown in FIG. 2B). However, this implementation of FIG. 2E is also illustrative and yet other implementations of the battery cell 120 are contemplated.

FIG. 2F illustrates an example in which the battery cell 120 is implemented as a pouch cell. As shown, the battery cell 120 may include a cell housing 224 that forms a flexible or malleable pouch housing. One or more layers of the anode 208, the cathode 212, and the electrolyte 210 disposed therebetween may be disposed (e.g., with separator materials between the layers) within the cell housing 224. In the implementation of FIG. 2F, the cell housing 224 may include a cross-sectional width 219 that is relatively thin. For example, the cell housing 224 in the implementation of FIG. 2F may be formed from a flexible or malleable material (e.g., a foil, such as a metal foil, or film, such as an aluminum-coated plastic film). The cross-sectional width 219 of the cell housing 224 may be as low as, or less than, 0.1 mm, 0.05 mm, 0.02 mm, or 0.01 mm to provide flexible or malleable housing for the pouch battery cell. In one or more implementations, a terminal 216 and a terminal 218 in the pouch cell implementation of FIG. 2F may be formed from conductive tabs (e.g., foil tabs) that are coupled (e.g., welded) to the anode 208 and the cathode 212 respectively, and sealed to the pouch that forms the cell housing 224 in these implementations. In the examples of FIGS. 2C, 2E, and 2F, the terminal 216 and the terminal 218 are formed on the same side (e.g., a top side) of the battery cell 120. However, this is merely illustrative and, in other implementations, the terminal 216 and the terminal 218 may formed on two different sides (e.g., opposing sides, such as a top side and a bottom side) of the battery cell 120. The terminal 216 and the terminal 218 may be formed on a same side or difference sides of the cylindrical cell of FIG. 2D in various implementations.

In one or more implementations, a battery module, a battery pack, a battery unit, or any other battery may include some battery cells that are implemented as solid-state battery cells and other battery cells that are implemented with liquid electrolytes for lithium-ion or other battery cells having liquid electrolytes. In one or more implementations, one or more of the battery cells may be included a battery module or a battery pack, such as to provide an electrical power supply for components of a vehicle and/or a building previously described, or any other electrically powered component or device. A cell housing of the battery cell can be disposed in the battery module, the battery pack, or installed in any of the vehicle, the building, or any other electrically powered component or device.

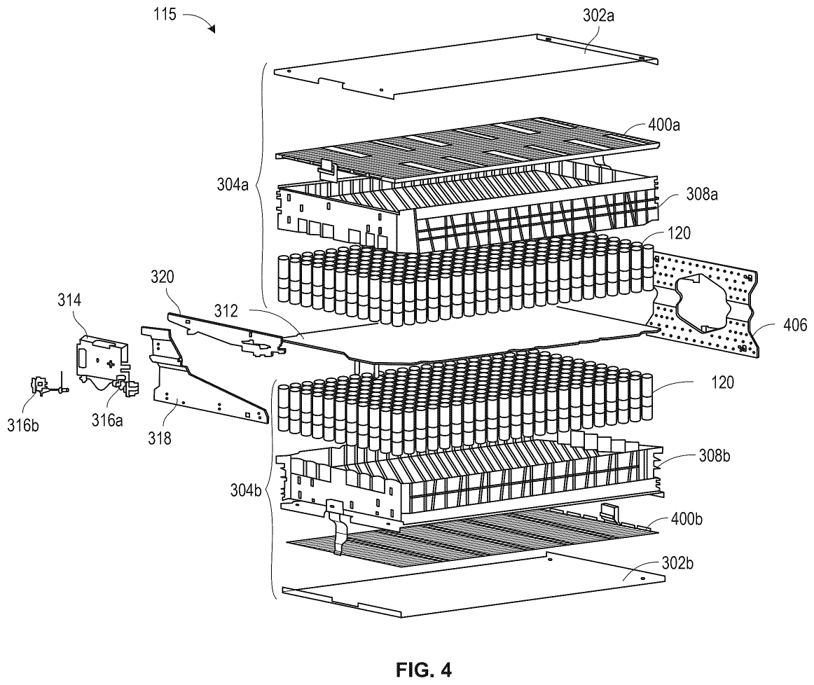

FIG. 3 illustrates a perspective view of a cover 302a for the battery module 115 in accordance with one or more implementations of the present disclosure. The cover 302a may represent an additional cover which will be shown and described below. In the example shown in FIG. 3, the battery module 115 includes a submodule 304a and a submodule 304b. Based on their respective positions and the orientation shown in FIG. 3, the submodule 304a and the submodule 304b may be referred to as a top submodule and a bottom submodule, respectively. As shown, the submodule 304a and the submodule 304b may include a cell carrier 308a and a cell carrier 308b, respectively. In one or more implementations, each of the cell carriers 308a and 308b may take the form of a monolithic unitary body (e.g., a molded body formed from plastic and/or other materials), and may include a structural feature 310a and a structural features 310b, respectively, along the sidewalls of thereof. The structural features 310a and 310b may reinforce the strength of the sidewalls of the cell carriers 308a and 308b, respectively, and thereby reduce or eliminate the need for additional structural reinforcing components for the battery module 115, such as shear walls attached to the cell carriers 308a and 308b. Also, a cold plate 312 is disposed between the submodule 304a and the submodule 304b. The cold plate 312 may be in thermal contact (e.g., thermally couple) with battery cells (not visible in FIG. 3) in the submodule 304a and battery cells (not visible in FIG. 3) in the submodule 304b in order to provide thermal control for respective battery cells of both the submodule 304a and the submodule 304b.

The cover 302a may be disposed on a top of the battery module 115, and an additional cover (shown below, similar to the cover 302a) may be disposed on a bottom of the battery module 115. Also, a balancing voltage and temperature (BVT) module 314 may communicatively couple to a thermistor assembly 316a and to a thermistor assembly 316b. The BVT module 314 may take the form a modular assembly of various electrical components to monitor or control components of the battery subassembly. For example, the BVT module 314 may include a circuit board that is attached to a housing of the BVT module 314. The BVT module 314 may include various connectors to couple with, for example, a thermistor, a voltage sensor, and/or a communication device, as non-limiting examples. The thermistor may measure a temperature of the battery module 115, a battery subassembly, and/or a battery cell thereof. The voltage sensor or balancer may sense or control voltage that flows through the battery module 115, a battery subassembly, and/or a battery cell thereof. The communication device may receive, transmit, or analyze data associated with the battery module 115, a battery subassembly, and/or a battery cell thereof. Several busbars may be integrated. For example, a busbar 318 (e.g., a positive busbar) may electrically couple to respective first terminals (e.g., the positive terminals) of the battery cells of the submodule 304a and the submodule 304b, and a busbar 320 (e.g., a negative busbar) may electrically couple to respective second terminals (e.g., the negative terminals) of the battery cells of the submodule 304a and the submodule 304b.

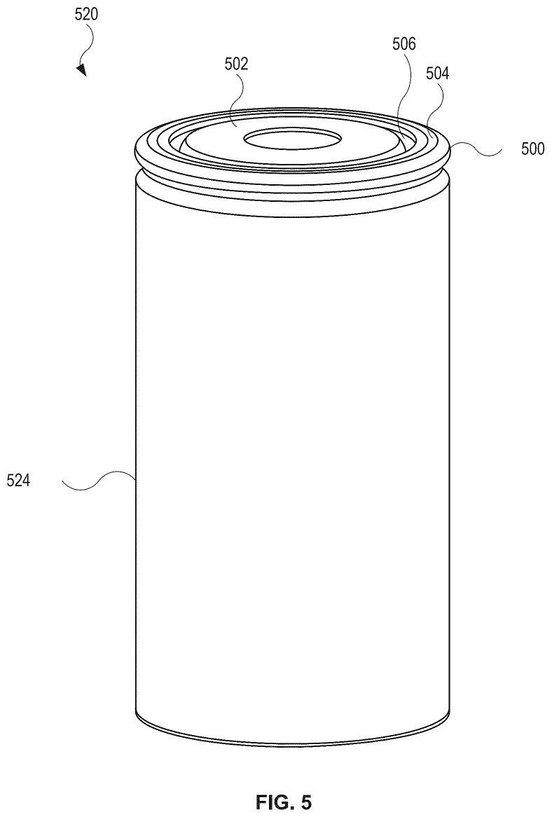

FIG. 4 illustrates an exploded perspective view of the battery module 115 of FIG. 3, in which the battery cells 120 of the submodule 304a and the battery cells 120 of the submodule 304b are shown. As shown, the cover 302a may be provided for the submodule 304a and a cover 302b may be provided for the submodule 304b. In one or more examples described herein, the battery module 115, a subset of the components of the battery module 115 (e.g., the submodule 304a, the submodule 304b, and/or another subset of the components of the battery module 115) shown in FIG. 3 and/or FIG. 4, or any other grouping of battery cells (e.g., including a battery pack that includes multiple battery modules and/or other battery subassemblies) may be referred to as a battery subassembly.

In the example shown in FIG. 4, a CCA 400a and a CCA 400b are also visible. As discussed in further detail hereinafter, when the battery module 115 is assembled, the CCAs 400a and 400b may each take the form of an apparatus that connects the respective terminals of the battery cells 120 of the submodule 304a and of the submodule 304b to the busbar 318 and the busbar 320. As shown in FIG. 4, a series busbar 406 may also be provided (e.g., on an opposing end of the cell carriers 308a and 308b from the end of the respective cell carriers at which the busbar 318 and the busbar 320 are mounted). For example, the series busbar 406 may electrically couple the battery cells 120 of the submodule 304a to the battery cells 120 of the submodule 304b.

The battery cells 120 of the submodule 304a may be inserted into a crate structure formed by the cell carrier 308a of the submodule 304a, and the battery cells 120 of the submodule 304b may be inserted into a crate structure formed by the cell carrier 308b of the submodule 304b. As shown in FIGS. 3 and 4, the orientation of the cell carrier 308a and the battery cells 120 of the submodule 304a may be substantially opposite (e.g., upside down with respect) to the orientation of the cell carrier 308b and the battery cells 120 of the submodule 304b. In this way, the CCA 400a and the CCA 400b may be provided at or near an outer layer of the submodule 304a and submodule 304b, respectively, for connection to the respective terminal(s) of the battery cells 120 disposed in the submodules 304a and 304b. Additionally, the cold plate 312 may thermally couple with the battery cells 120 of the submodule 304a and with the battery cells 120 of the submodule 304b. In this regard, the cold plate 312 may dissipate thermal energy from the battery cells 120 of the submodule 304a and from the battery cells 120 of the submodule 304b.

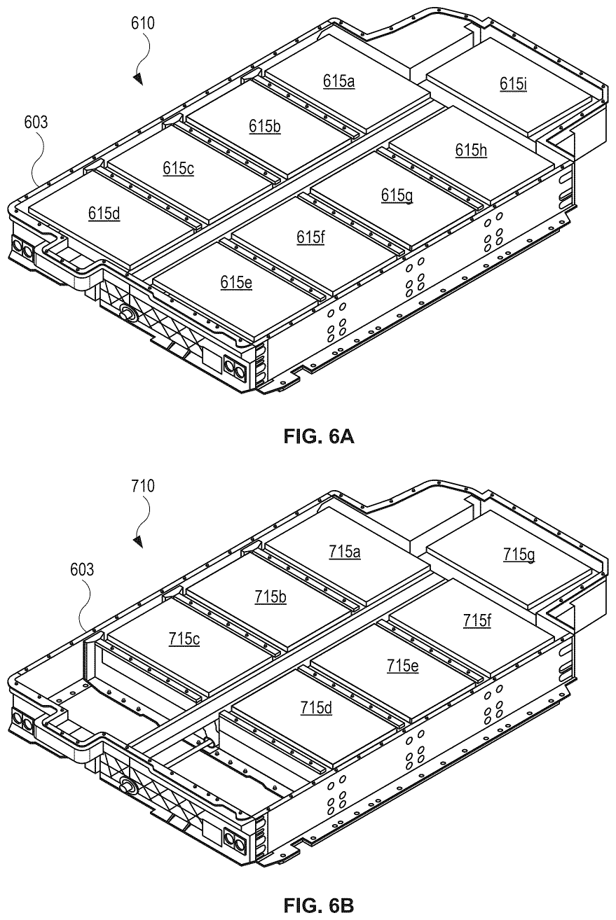

FIG. 5 illustrates a perspective view of an example of a battery cell 520, implemented as a cylindrical cell with a cylindrical cell housing 524, in accordance with one or more implementations. In the example of FIG. 5, the battery cell 520 includes a cap 500 that includes a central portion 502 and a peripheral rim 504. In one or more implementations, the central portion 502 may be implemented as a terminal, such as a positive terminal of the battery cell 520. In one or more implementations, the peripheral rim 504 may be implemented as a terminal, such as a negative terminal of the battery cell 520. In one or more implementations, the battery cell 520 may include a gasket 506 that is disposed at least partially beneath the peripheral rim 504. For example, the gasket 506 may seal an internal cavity of the battery cell 520 (e.g., enclosed by the cylindrical cell housing 524 and the cap 500) from the external environment of the battery cell 520.

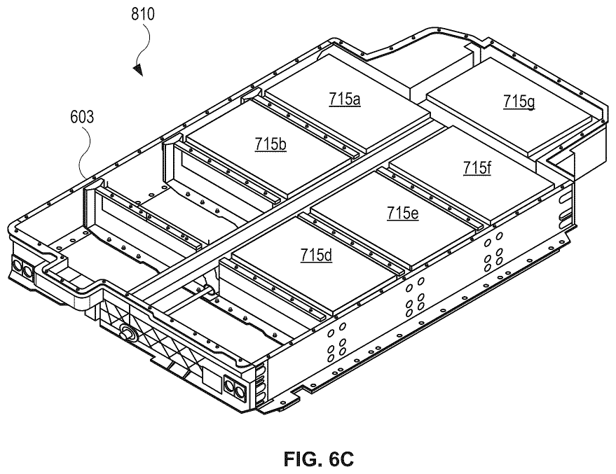

FIG. 6A. FIG. 6B, and FIG. 6C illustrate perspective views of examples of battery packs in accordance with one or more implementations of the present disclosure. Each of the battery packs shown in FIGS. 6A-6C may include several battery modules in a battery frame. Each battery module shown in FIGS. 6A-6C may include any feature shown and/or described herein for a battery module (e.g., battery module shown in FIG. 4). Each of the battery modules shown in FIGS. 6A-6C may be disposed in a battery pack frame, which may include any feature shown and/or described herein for a battery pack frame (e.g., battery pack frame 203 shown in FIG. 2A).

Referring to FIG. 6A, a battery pack 610 includes a battery module 615a, a battery module 615b, a battery module 615c, a battery module 615d, a battery module 615e, a battery module 615f, a battery module 615g, a battery module 615h, and a battery module 615i. Each of the aforementioned battery modules are disposed in a battery pack frame 603. Referring to FIG. 6B, a battery pack 710 includes a battery module 715a, a battery module 715b, a battery module 715c, a battery module 715d, a battery module 715e, a battery module 715f, and a battery module 715g. Each of the aforementioned battery modules are disposed in the battery pack frame 603. Referring to FIG. 6C, a battery pack 810 includes a battery module 715a, a battery module 715b, a battery module 715d, a battery module 715e, a battery module 715f, and a battery module 715g. Each of the aforementioned battery modules are disposed in the battery pack frame 603.

Based on the different number of battery modules between the battery pack 610 in FIG. 6A, the battery pack 710 in FIG. 6B, and the battery pack 810 in FIG. 6C, the battery packs 610, 710, and 810 may provide different energy output, including a different voltage and/or a different energy storage capacity. For example, the battery pack 610, having more battery modules, may provide a higher voltage and/or greater energy storage capacity. However, while the numbers of battery modules for a battery pack may differ between the battery pack 610 and the battery pack 710 in FIG. 6A and FIG. 6B, respectively, a battery pack frame (e.g., battery pack frame 603) may include the same size and shape. In this regard, a battery pack frame having a unitary size and shape may be used with different numbers of battery modules. Beneficially, vehicles integrating the battery pack frame 603 may be equipped with a different number of battery modules, thus offering users different options based on user preferences, including but not limited to, acceleration (dependent upon voltage), driving range (dependent upon energy storage capacity), and cost (dependent upon the number of battery modules).

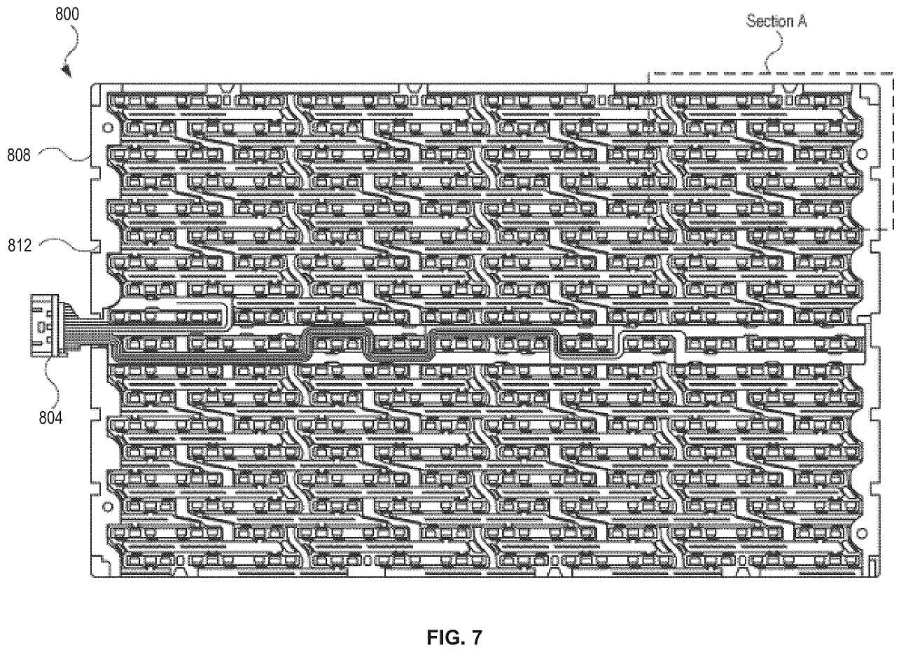

FIG. 7 illustrates a plan view of a CCA 800 for a battery module (e.g., battery module 115) in accordance with one or more implementations. The CCA 800 may be representative of other CCAs shown and/or described herein, such as the CCA 400a and the CCA 400b shown in FIG. 4. As shown, the CCA 800 may include a connector 804. The connector 804 may connect (e.g., mechanically and electrically connect) with another battery module or a drive unit (e.g., motor) of a vehicle, as non-limiting examples. The CCA 800 may further include one or more edge portions 808, and one or more notches 812 (e.g., strain relief notches) in each of the one or more edge portions 808. Although not expressly labeled in FIG. 7, the CCA 800 may include one or more tabs and one or more interconnects.

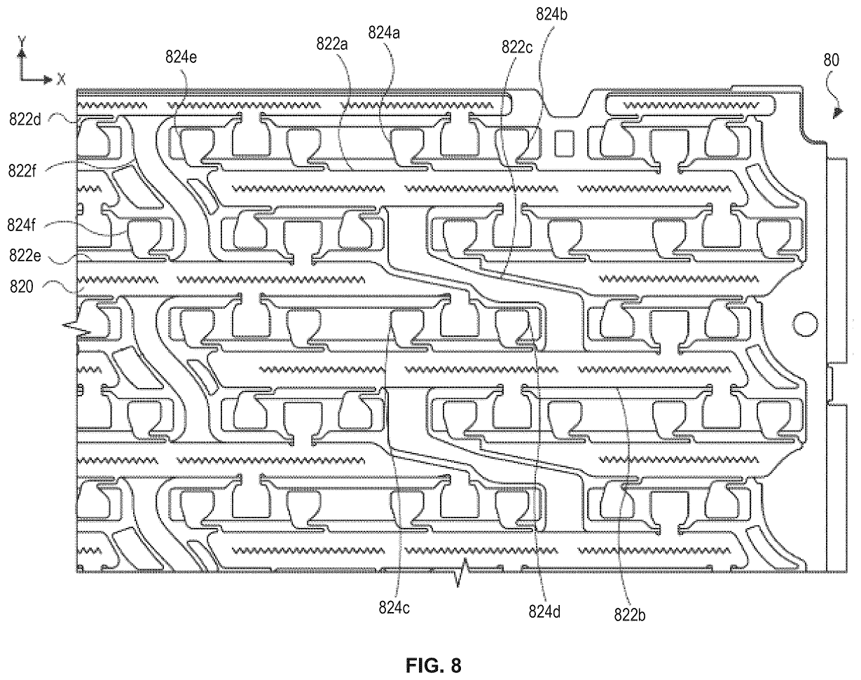

FIG. 8 illustrates an enlarged plan view of the CCA 800 of Section A in FIG. 7, showing additional features in accordance with one or more implementations of the present disclosure. The CCA 800 is designed to connect (e.g., mechanically and electrically connect) with multiple battery cells of a battery module (not shown in FIG. 8). As shown, the CCA 800 includes an electrically conductive layer 820. The electrically conductive layer 820 may take the form of a metal layer (e.g., aluminum, aluminum foil) having a thickness approximately in the range of 100-200 microns.

The electrically conductive layer 820 may include several interconnect portions, or interconnects, and tabs. For example, the electrically conductive layer 820 may include an interconnect portion 822a and an interconnect portion 822b. In one or more implementations, the interconnect portions 822a and 822b are parallel, or at least substantially parallel, with respect to each other. Additionally, the electrically conductive layer 820 may include an interconnect portion 822c connected to, and positioned between, the interconnect portion 822a and the interconnect portion 822b. Further, the electrically conductive layer 820 may include an interconnect portion 822d, an interconnect portion 822e, and an interconnect portion 822f connected to, and positioned between, the interconnect portion 822d and the interconnect portion 822e. The interconnect portions 822d and 822f may be parallel with respect to each other.

Several interconnect portions may include one or more tabs extending therefrom. For example, the interconnect portion 822a includes a tab 824a and a tab 824b. Further, the interconnect portion 822b includes a tab 824c and a tab 824d. The tabs 824a, 824b, 824c, and 824d are representative of several additional tabs of the electrically conductive layer 820.

At least some interconnect portions may include different features, including different curvatures (e.g., radius of curvature at different locations). For example, the interconnect portions 822c and 822f, each of which is connected to and positioned between respective interconnect portions, include different curvatures. Based on the difference in respective curvatures, the interconnect portion 822c, having a relatively smaller radius of curvature, includes greater/sharper bends as compared to those of the interconnect portion 822f, having the relatively larger radius of curvature. Also, each of the interconnect portions 822c and 822f include both an X-component and a Y-component (of Cartesian coordinates). Additionally, the X-component (e.g., components in one direction) of the interconnect portion 822c is greater than the X-component of the interconnect portion 822f. Put another way, the interconnect portion 822c spans a greater distance than the interconnect portion 822f along the same axis (e.g., the X-axis). Further, based on the difference in curvature, the interconnect portion 822c may be positioned between more tabs than the interconnect portion 822f. For example, the interconnect portion 822c is positioned between the tab 824a and the tab 824c, as well as between the tab 824b and the tab 824d. Conversely, the interconnect portion 822f is positioned between a tab 824e and a tab 824f.

Based in part on the interconnect portions, the CCA 800 may place some battery cells electrically in series with each other, while placing some battery cells electrically in parallel with each other. For example, in one or more implementations, the CCA 800 may place six groups of battery cells electrically in series with each other, and may further place seventy two battery cells electrically in parallel with each other. Further, in one or more implementations, the CCA 800 may place eight groups of battery cells electrically in series with each other, and may further place fifty four battery cells electrically in parallel with each other. Some battery cells that are electrically connected in series with some battery cells may further be electrically connected in parallel with other battery cells.

The desired number of groups of battery cells electrically connected in series and parallel may be adjusted based on the interconnect portions such as the interconnect portions 822c and 822f (as well as similar interconnect portions). For example, for a CCA utilizing interconnect portions similar to the interconnect portion 822f (e.g., without using interconnect portions similar to interconnect portion 822c), the CCA may place six groups of battery cells electrically in series with each other, and may further place seventy two battery cells electrically in parallel with each other. Conversely, for a CCA utilizing interconnect portions similar to both the interconnect portion 822c and the interconnect portion 822f (e.g., the CCA 800), the CCA may place eight groups of battery cells electrically in series with each other, and may further place fifty four battery cells electrically in parallel with each other. Beneficially, the number of battery modules of a battery pack may be altered (e.g., reduced) while the voltage output remains unchanged. Moreover, based on the use of the interconnect portion 822c, the various tabs (e.g., tabs 824a, 824b, 824c, and 824d, representative of additional tabs) and other interconnect portions (e.g., interconnect portions 822a, 822b, 822d, and 822e, representative of additional interconnect portions) need not be repositioned, resized, and/or reshaped, while a CCA (e.g., the CCA 800) may alter the number of groups of battery cells electrically coupled in series and the number of battery cells electrically coupled in parallel.

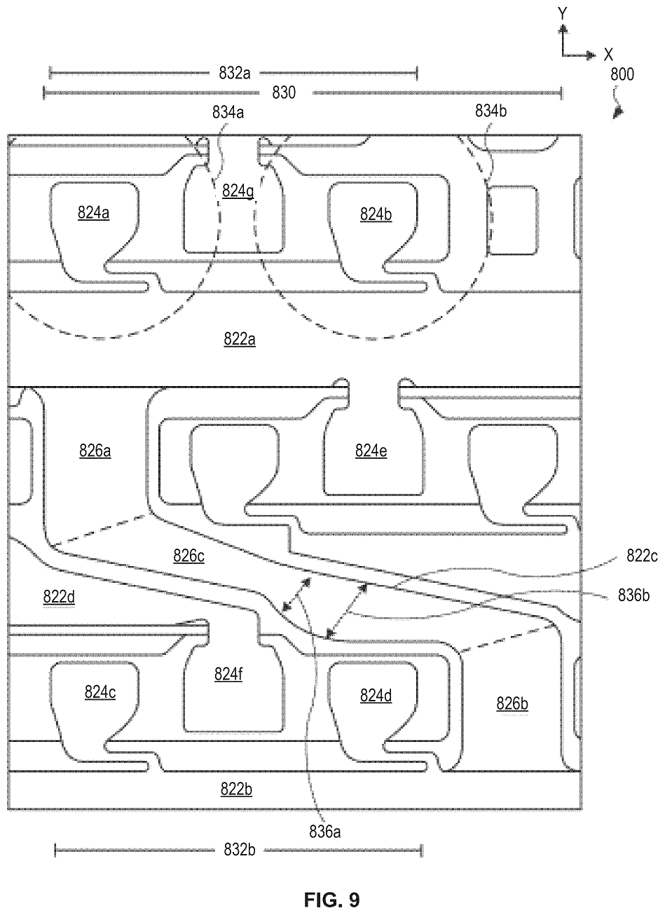

FIG. 9 illustrates an additional enlarged plan view of the CCA 800 shown in FIG. 8, showing additional features in accordance with one or more implementations of the present disclosure. The interconnect portion 822c (representative of similar interconnect portions shown in FIG. 8) may include a section 826a connected (e.g., electrically and mechanically connected) with the interconnect portion 822a. The interconnect portion 822c may further include a section 826b connected (e.g., electrically and mechanically connected) with the interconnect portion 822b. The interconnect portion 822c may further include a section 826c connected (e.g., electrically and mechanically connected) with the section 826a and the section 826b. Based on its location, the section 826c may be characterized as a middle section or central section. The dotted lines superimposed on the interconnect portion 822c represent a boundary, or an approximate boundary, between adjacent sections (e.g., sections 826a, 826b, and 826c) of the interconnect portion 822c. Based in part on the section 826c being diagonally positioned relative to the sections 826a and 826b, the interconnect portion 822c may pass around some tabs (e.g., tabs 824a and 824d) and may extend between some tabs (e.g., 824a, 824b, 824c, and 824d).

As compared to a corresponding middle or central section of the interconnect portion 822f (shown in FIG. 8), the section 826c of the interconnect portion 822c may include a greater dimension (e.g., longer than) that of the middle section of the interconnect portion 822f. For example, the section 826c includes a dimension 830 (e.g., width along the X-axis). Based on the dimension 830, the section 826c may at least span a dimension 832a defined as a distance between the tabs 824a and 824b, including outer edges of the tabs 824a and 824b (e.g., adjacent tabs). Additionally, the section 826c may at least span a dimension 832b defined by a distance between the tabs 824c and 824d (e.g., adjacent tabs), including outer edges of the tabs 824c and 824d. In this regard, the dimension 830 of section 826c may be greater than dimension 832a, and the dimension 830 of section 826c may be greater than dimension 832b. Moreover, the section 826c may space a dimension (represented by the dimension 830) from at least the tab 824a to the tab 824d along the X-axis. Similarly, the section 826c may space a dimension (represented by the dimension 830) from at least the tab 824c to the tab 824b along the X-axis. Conversely, a corresponding middle section of the interconnect portion 822f (shown in FIG. 8) may not span a dimension of two adjacent tabs, and accordingly the interconnect portions 822c spans a greater distance (along the same axis) than the interconnect portion 822f.

The electrically conductive layer 820 may further include a tab 824e connected to and extending from the interconnect portion 822a, as well as a tab 824f connected to and extending from the interconnect portion 822d. As shown, the section 826c of the interconnect portion 822c is positioned between the tabs 824e and 824f. Several tabs may be oriented in different directions. For example, the tabs 824a, 824b, 824c, and 824d are oriented along one direction (e.g., along the positive direction of the Y-axis) and the tabs 824e and 824f are oriented along another direction (e.g., along the negative direction of the Y-axis). In this regard, the tabs 824a, 824b, 824c, and 824d may be oriented along an opposite direction as that of the tabs 824e and 824f.

The electrically conductive layer 820 may further include a tab 824g positioned between the tabs 824a and 824b. The tabs 824a, 824b, and 824g may electrically connect to battery cells. For example, a battery cell 834a (shown as dotted lines) may include a positive terminal (not shown in FIG. 9) that connects to the tab 824a and a negative terminal (not shown in FIG. 9) that connects to the tab 824g. Additionally, a battery cell 834b (shown as dotted lines) may include a positive terminal (not shown in FIG. 9) that connects to the tab 824b and a negative terminal (not shown in FIG. 9) that connects to the tab 824g. Further, it can be seen that the tab 824g is positioned between the tabs 824a and 824b. In this regard, the section 826c of the interconnect portion 822c may span, based on the dimension 830, a distance of at least three tabs (e.g., tabs 824a, 824b, and 824g).

In order to further fit between tabs and other relatively small spaces, the section 826c of the interconnect portion 822c may include different dimensions. For example, the section 826c may include a dimension 836a (e.g., width) and a dimension 836b (e.g., width). As shown, the dimensions 836a and 836b are different, as the dimension 836a is smaller than the dimension 836b. Beneficially, interconnect portions (e.g., interconnect portion 822c) may further conform to existing architecture (e.g., position of the tabs 824c and 824d) of the CCA 800.

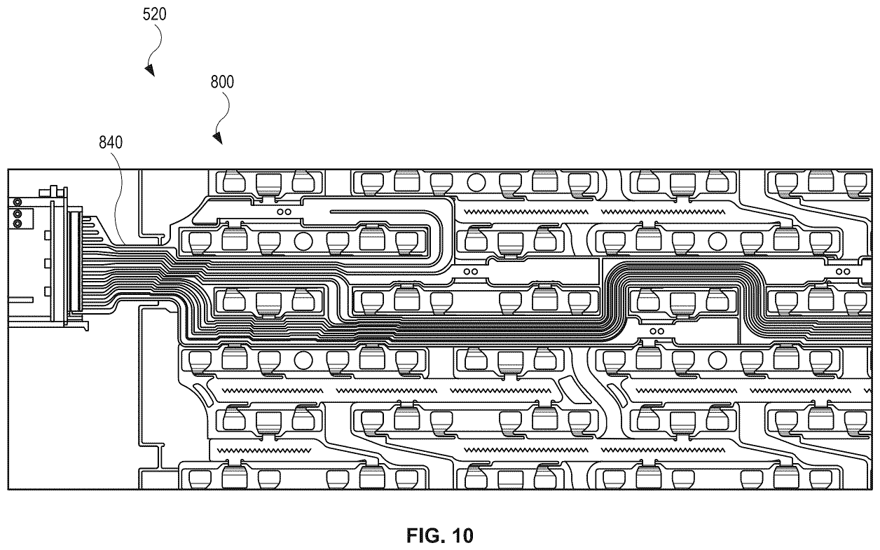

FIG. 10 illustrates an additional enlarged plan view of the CCA 800 shown in FIG. 7, showing features of the voltage sense harness 840 in accordance with one or more implementations of the present disclosure. The voltage sense harness 840 is designed to provide information, such as voltage and current, to a battery management system (not shown in FIG. 10). In one or more implementations, the number of electrical traces of the voltage sense harness 840 may change when the number of battery modules of a battery pack are changed.

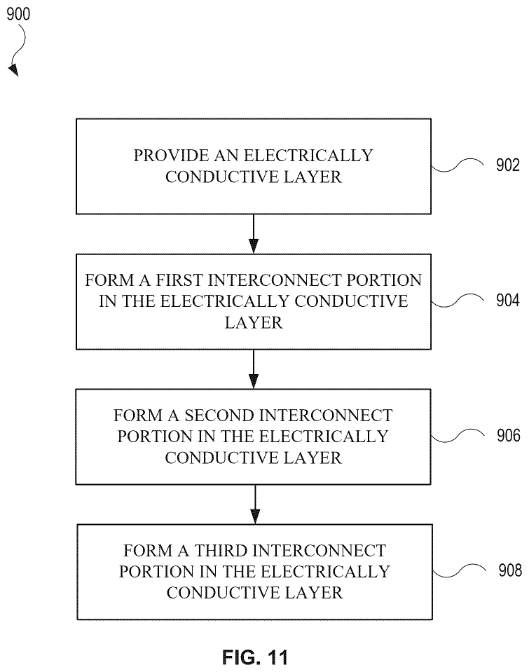

FIG. 11 illustrates a flow diagram showing an example of a process 900 that may be performed for forming a current collector assembly in accordance with one or more implementations of the present disclosure. For explanatory purposes, the process are primarily described herein with reference to CCAs shown in FIGS. 4 and 7-9. However, the process are not limited to the CCAs shown in FIGS. 4 and 7-9, and one or more blocks (or operations) of the process may be performed by one or more other components of other suitable moveable apparatuses, devices, or systems. Further for explanatory purposes, some of the blocks of the process are described herein as occurring in serial, or linearly. However, multiple blocks of the process may occur in parallel. In addition, the blocks of the process need not be performed in the order shown and/or one or more blocks of the process need not be performed and/or can be replaced by other operations.

At block 902, an electrically conductive layer is provided. The electrically conductive layer may include a metal (e.g., aluminum). At least some portions of the electrically conductive layer may be covered by one or more electrically insulating layers.

At block 904, a first interconnect portion is formed in the electrically conductive layer. The first interconnect portion (e.g., interconnect portion 822a shown in FIG. 8) may include one or more tabs (extending from the first interconnect portion), such as the tabs 824a and 824b (shown in FIG. 8). The tabs may connect (e.g., electrically and mechanically connect) to one or more battery cells.

At block 906, a second interconnect portion is formed in the electrically conductive layer. The second interconnect (e.g., interconnect portion 822b shown in FIG. 8) portion may also include one or more tabs (extending from the second interconnect portion), such as the tabs 824c and 824d (shown in FIG. 8).

At block 908, a third interconnect portion is formed in the electrically conductive layer. The third interconnect portion (e.g., interconnect portion 822c shown in FIG. 8) may be connected to the first interconnect portion and the second interconnect portion. The third interconnect portion may include a dimension (e.g., section 826c) that spans a dimension from at least the tabs extending from the first interconnect portion. The third interconnect portion may include a dimension that spans a dimension from at least the tabs extending from the second interconnect portion.

Aspects of the subject technology can help extend the life of a battery in a vehicle. This can help facilitate the functioning of and/or proliferation of batteries, which can positively impact the climate by reducing greenhouse gas emissions.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An apparatus, comprising:
a current collector assembly comprising an electrically conductive layer, the electrically conductive layer comprising:
a first interconnect portion connected to a first tab and to a second tab;
a second interconnect portion; and
a third interconnect portion connected to the first interconnect portion and the second interconnect portion, wherein the third interconnect portion spans from at least the first tab to the second tab.

2. The apparatus of claim 1, wherein:
the first tab is separated from the second tab by a first distance, and
the third interconnect portion spans a second distance greater than the first distance.

3. The apparatus of claim 1, wherein the third interconnect portion comprises:
a first width, and
a second width different from the first width.

4. The apparatus of claim 1, wherein:
the first interconnect portion comprises a third tab,
the third interconnect portion spans from at least the first tab, the second and the third tab.

5. The apparatus of claim 4, wherein:
the second interconnect portion comprises a fourth tab, and
the third interconnect portion is positioned between the third tab and the fourth tab.

6. The apparatus of claim 5, wherein:
the second interconnect portion comprises a fifth tab,
the fourth tab is separated from the fifth tab by a first distance, and
the third interconnect portion spans a second distance greater than the first distance.

7. The apparatus of claim 6, wherein the third interconnect portion is positioned between the third tab and the fifth tab.

8. The apparatus of claim 6, wherein the third interconnect portion is positioned between the second tab and the fifth tab.

9. A battery subassembly, comprising:
a current collector assembly electrically coupled with one or more battery cells, the current collector assembly comprising an electrically conductive layer that comprises:
a first tab extending from a first interconnect portion;
a second tab extending from a second interconnect portion; and
a third interconnect portion comprising:
a first section extending from the first interconnect portion,
a second section extending from the second interconnect portion, and
a third section connected to the first section and the second section,
wherein the third section is positioned between the first tab and the second tab and spans from at least the first tab to the second tab.

10. The battery subassembly of claim 9, wherein the first interconnect portion is parallel with respect to the second interconnect portion.

11. The battery subassembly of claim 9, wherein the third interconnect portion further comprises:
a first width, and
a second width different from the first width.

12. The battery subassembly of claim 9, wherein:
the electrically conductive layer further comprises a third tab extending from the first interconnect portion,
the first tab and the third tab are separated by a first distance, and
the third interconnect portion spans a second distance greater than the first distance.

13. The battery subassembly of claim 9, wherein the electrically conductive layer further comprises:
a fourth interconnect portion positioned between the first interconnect portion and the second interconnect portion;
a fifth interconnect portion; and
a sixth interconnect portion connected to the fourth interconnect portion and the fifth interconnect portion, wherein:
the third interconnect portion spans a first distance, and
the sixth interconnect portion spans a second distance less than the second distance.

14. The battery subassembly of claim 13, wherein the fourth interconnect portion is parallel with respect to the first interconnect portion and with respect to the second interconnect portion.

15. The battery subassembly of claim 13, wherein:
the electrically conductive layer further comprises a third tab extending from the fourth interconnect portion, and the one or more battery cells comprises:
a first battery cell electrically connected to the first tab;
a second battery cell electrically connected to the second tab, the second battery cell electrically connected in parallel with the first battery cell; and
a third battery cell electrically connected to the second tab, the third battery cell electrically connected in series with the first battery cell and the second battery cell.

16. The battery subassembly of claim 15, wherein:
the first tab is configured to electrically connect to a positive terminal of the first battery cell, and
the third tab is configured to electrically connect to a negative terminal of the third battery cell.

17. A vehicle, comprising:
a current collector assembly comprising an electrically conductive layer electrically coupled with one or more battery cells, the electrically conductive layer comprising:
a first interconnect portion connected to a first tab and to a second tab;
a second interconnect portion; and
a third interconnect portion connected to the first interconnect portion and the second interconnect portion, wherein the third interconnect portion spans from at least the first tab to the second tab.

18. The vehicle of claim 17, wherein the third interconnect portion comprises:
a first section extending from the first interconnect portion,
a second section extending from the second interconnect portion, and
a third section connected to the first section and the second section, the third section positioned between the first tab and the second tab, wherein the first section comprises a first width, and the third section comprises a second width different from the first width.

19. The vehicle of claim 17, wherein the electrically conductive layer further comprises:
a fourth interconnect portion positioned between the first interconnect portion and the second interconnect portion;
a fifth interconnect portion; and
a sixth interconnect portion connected to the fourth interconnect portion and the fifth interconnect portion, wherein:
the third interconnect portion spans a first distance, and
the sixth interconnect portion spans a second distance less than the second distance.

20. The vehicle of claim 19, wherein:
the electrically conductive layer further comprises a third tab extending from the fourth interconnect portion, and the one or more battery cells comprises:
a first battery cell electrically connected to the first tab;
a second battery cell electrically connected to the second tab, the second battery cell electrically connected in parallel with the first battery cell; and
a third battery cell electrically connected to the second tab, the third battery cell electrically connected in series with the first battery cell and the second battery cell.
